(19) United States
(12) Patent Application Publication
(10) Pub. No.: US 2005/0070399 A1
(43) Pub. Date: Mar. 31, 2005

(54) Planetary gear motor assembly and method of manufacture

(75) Inventor: William H. Redfield, Lake Forest, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Molon Motor & Coil Corp., Rolling Meadows, IL (US)

(21) Appl. No.: 10/670,471

(22) Filed: Sep. 26, 2003

(51) Int. Cl. G07D 1/00; F16H 57/08

(52) U.S. Cl. 475/331

(57) ABSTRACT

A planetary gear motor assembly opens and closes a shutter door on a coin dispensing mechanism. The assembly includes a cage having a pair of annular plates with a plurality of cluster gears composed of upper and lower planet gears sandwiched between the pairs of annular plates. The improvement is a plurality of pins on which the cluster gears are placed. Each of the pins is staked at opposite ends to the pair of annular plates so that structural integrity of the assembled cage is retained during rotation and abrupt stopping of the planet gears. A method of manufacturing a planetary gear motor assembly for opening and closing a shutter door on a coin dispensing mechanism includes several steps. Initially, there is assembled a cage having a pair of annular plates with a plurality of cluster gears composed of upper and lower planet gears sandwiched between the pair of annular plates. The improvement is a step of staking a plurality of pins, on which the cluster gears are placed, at opposite ends to the pair of annular plates, whereby structural integrity of the cage is retained during rotation and abrupt stopping of the planet gears.

### BACKGROUND OF THE INVENTION

1. Field of the Invention

The field of the invention relates to planetary gear motor assemblies, in particular to a type used to operate a shutter door on a coin dispensing mechanism which delivers change from either a vending machine or a bill changing machine, and a method for manufacturing such planetary gear motor assemblies.

2. Discussion of the Prior Art

In coin vending and bill changing machines of the prior art, a service technician would daily or at least weekly, depending upon volume of usage, load such machines with money to be dispensed by stacking bills and coins manually one on top of the other. This task was necessarily labor-intensive and time-consuming, particularly as wages increased. Later, automatic stackers were developed, such as the “Coin Tube Monitor” covered by U.S. Pat. No. 5,092,816 which was issued in the name of Levasseur on Mar. 3, 1992.

Such machines had the dispensing of coins controlled by a motor, such as element 11 shown in FIG. 1 of U.S. Pat. No. 3,998,357 which was issued on Dec. 21, 1976, in the name of Levasseur.

To speed up the loading of such machines, devices have been recently developed to allow the service technician merely to dump large quantities of sorted nickels, dimes and quarters into separate compartments for holding such coins for subsequent dispensing. Such a “Coin Changer” is protected by U.S. Pat. No. 6,346,039 which was granted to Orton et al. on Feb. 12, 2002.

At the bottom of each separate compartment, there is a shutter door which is opened and closed by an output gear driven by a motor. Such a door may be similar but not identical in appearance to the “Payout Slide” which is the subject of U.S. Design Pat. No. D422,639 that was granted in the name of Bell et al. on Apr. 11, 2000.

However, there have been problems in developing a suitable output gear driven by a motor to open and close the shutter door in such a manner that only one coin at a time is dispensed consistently from the large compartment holding a jumble of the same kind of coin.

To solve this problem, planetary gear motor assemblies have been investigated. For example, Jonsson discloses a “Planetary Type of Gear” in U.S. Pat. No. 4,366,727 which was issued on Jan. 4, 1983. This prior art device of Jonsson is characterized by several features such as a planet assembly supported by bearings. Also, the device has an output shaft which is bearing-supported on a centerline with an input shaft. Furthermore, the device has only two planet gears. Additionally, Jonsson states in column 1, lines 35-39, that “it is absolutely necessarily required for a good function that the center of the planet be built steady and carefully centered on main shafts carried in bearings . . . .”

To the contrary, this inventor has found that, by building prototypes and conducting tests, it is absolutely necessary for the gears to be allowed to seek their own centers when using some plastic gears in the gear train and other mechanical parts which are susceptible to breakage due to necessary manufacturing tolerances for plastic gears. As a result, adequate clearance must be provided such that the gears are allowed to float on their centers. Because of these different characteristics, the planetary gear of Jonsson is not satisfactory for carrying out the work required to accomplish the task of reliably opening and closing the shutter door at the bottom of the compartment holding a large accumulation of loose coins of the same denomination.

### SUMMARY OF THE INVENTION

A planetary gear motor assembly is mounted in a coin dispensing mechanism in such a way that a protruding lug on an upper surface of an output gear fits into a mating slot in a shutter door. When the motor is energized by electricity supplied from a power source, the output gear rotates at least 180°. This rotation of the output gear is translated into a linear motion which raises the shutter door. This door has a round hole that is slightly larger than a coin which it is designed to carry, whether the coin is a nickel, a dime or a quarter. The door is positioned at an opening in the bottom of a large compartment in which accumulated coins of the same denomination are loosely held in a jumble.

When the door is raised by the protruding lug on the output gear of the motor, a coin should drop into the round hole in the door. The motor will hold the door open in this position for enough time so that only one coin is captured and lodged in the round hole. The motor is then reversed in order to lower the shutter door. When the door returns to its initial rest position, the captured coin falls out from the other side of the round hole and is dropped into another device that either counts or senses the coin. If no coin appears in the round hole, this device electronically instructs the gear motor to repeat the cycle described above. Each cycle occurs in a very short period of time, usually less than a second.

The invention also relates to a method for manufacturing the planetary gear motor assembly. One step of the inventive method is press-fitting a plurality of metal pins into top and bottom annular plates on opposite sides of plural pairs of planet gears. A key step of the method is staking the ends of the pins with either a hardened steel tool or a carbide tool so that the ends of the metal pins deform and slightly flare out over the upper surface of the top annular plate and the lower surface of the bottom annular plate. An advantage of this staking step is that the structural integrity of the assembled cage is retained throughout the application life of the gear motor.

### BRIEF DESCRIPTION OF THE DRAWINGS

A more complete appreciation of the invention and many of its other advantages will be readily obtained as the same becomes better understood by reference to the following detailed description when considered in connection with the accompanying drawings, wherein:

FIG. 1 is an exploded perspective view of the planetary gear motor assembly.

FIG. 2 is a side elevational view of the assembled planetary gear motor.

FIG. 3 is a bottom plan view of the planetary gear motor assembly.

FIG. 4A is an exploded perspective view of the cage.

FIG. 4B is a side elevational view of the assembled cage.

FIG. 4C is a partially broken away, top plan view of the assembled cage.

FIG. 5A is a top plan view of the output gear.

FIG. 5B is a side elevational view of the output gear.

FIG. 6 is a perspective view of a coin dispensing mechanism in which the planetary gear motor assembly operates.

FIG. 7A is a top plan view of a molded ring surrounding the planet gears.

FIG. 7B is a cross-sectional view taken along line 7B-7B in FIG. 7A

### DETAILED DESCRIPTION OF THE PREFERRED EMBODIMENTS

Referring now to the drawings, like reference numerals designate identical or corresponding parts throughout the several views.

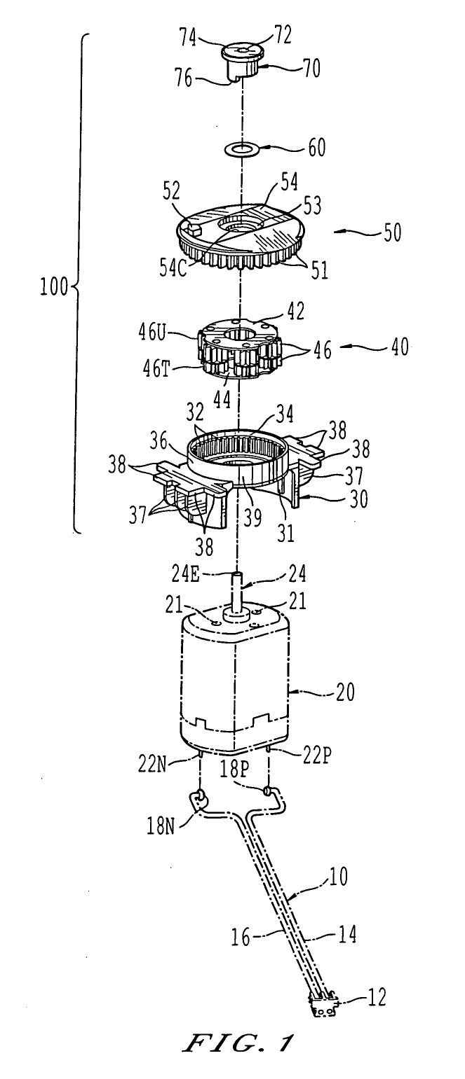

In FIG. 1, there is seen an exploded perspective view of the preferred embodiment of a planetary gear motor assembly 100. Beneath the assembly 100, there is a harness 10 having at one end a jack 12 for receiving electric current from an external power source (not shown). A positive wire 14 carries the current from the jack 12 to a connector 18P. Similarly, there is a negative wire 16 which extends from the jack 12 to a connector 18N.

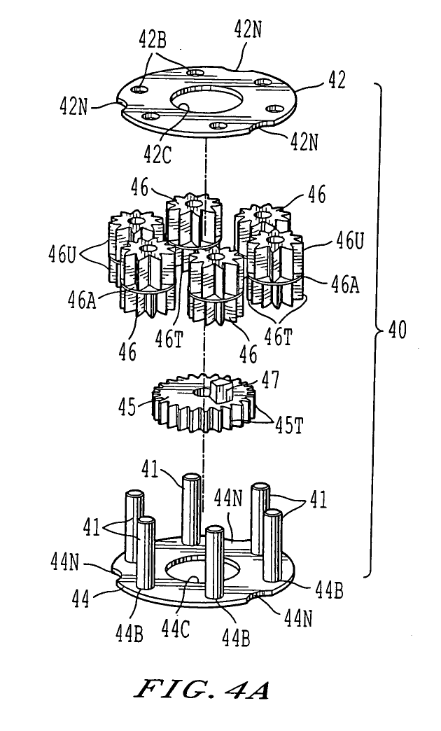

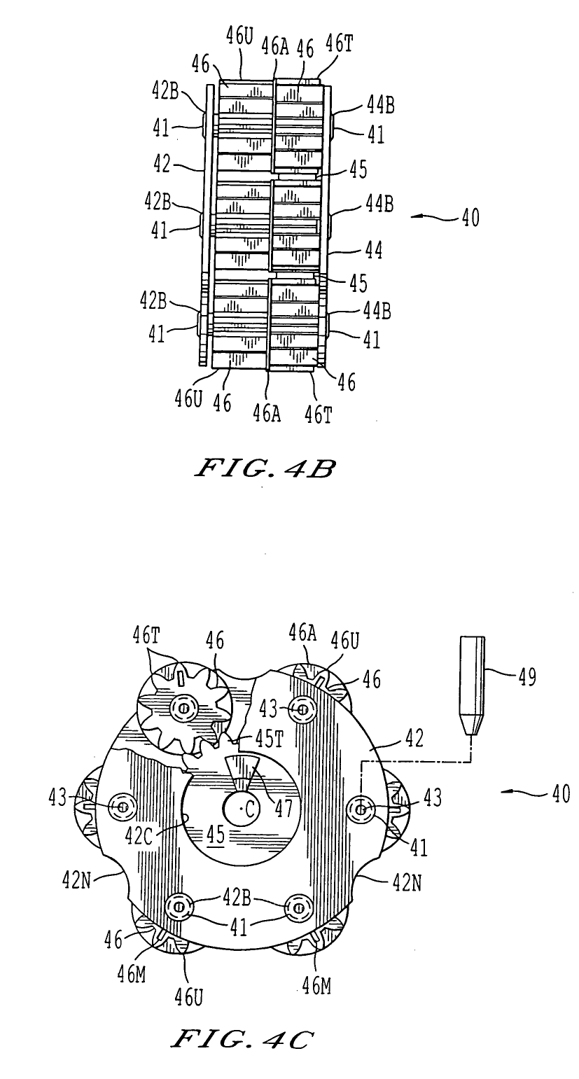

A direct current (D.C.) motor 20 has on its bottom end a pair of terminals 22P and 22N to which the connectors 18P and 18N, respectively, are attached. A shaft 24 protrudes from a top end of the motor 20 and is long enough to extend through the assembly 100. Because there are center holes in a housing 30, a cage 40, an output gear 50 and a washer 60, the shaft 24 engages with a cap 70. An upper end 24E of the shaft 24, when extended into a center hole 72 in a top surface 74 of the cap 70, is preferably flush with the top surface 74 but may protrude slightly above or may be recessed slightly below such top surface 74 when the assembly 100 is put together. The cap 70 also has a leg 76 which engages with the cage 40 in a manner to be described later in reference to FIG. 4A.

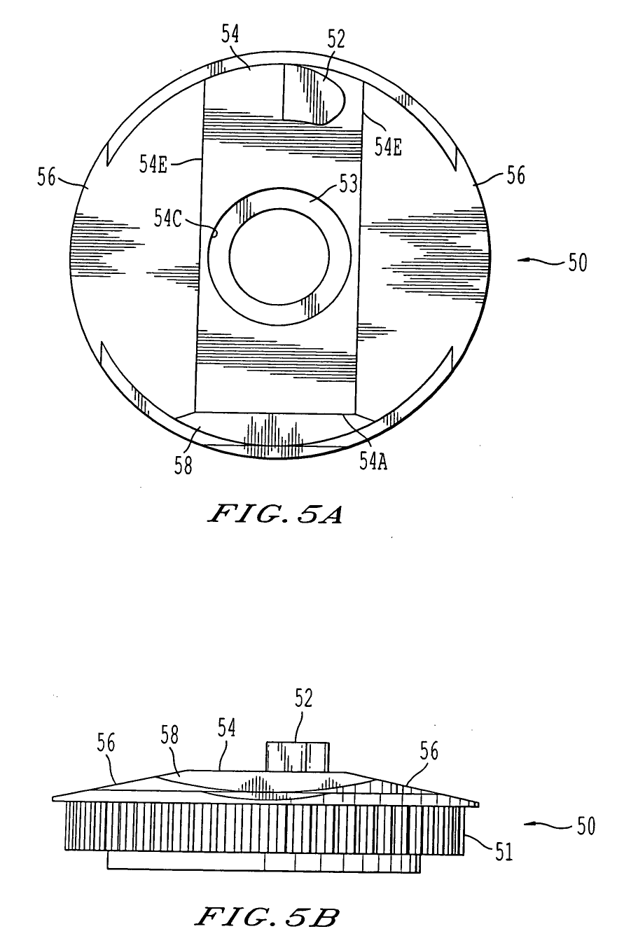

Still referring to FIG. 1, the cage 40 has a top annular plate 42, a bottom annular plate 44, and a plurality of stacked pairs of upper and lower planet gears 46 sandwiched therebetween. Outer edges of teeth 46T on the lower planet gears 46 engage with a plurality of involute spur gear teeth 32 which stand vertically along a wall 34 inside an outer ring 36 of the housing 30. Wings 38 are supported by brackets 37 and extend outwardly from an exterior wall 39. These wings 38 are configured for mounting the entire assembly 100 into a desired position inside a coin dispensing mechanism such as an element 10 in FIG. 1 of the U.S. Pat. No. 3,998,357 issued to Levasseur or a module 2 in FIG. 5 of the U.S. Pat. No. 6,346,039 issued to Orton et al.

The planetary gear motor assembly 100 may be operated in environments that are either hot, cold or room temperature. As noted above, the stacked pairs of upper and lower planet gears 46 are held between the annular plates 42 and 44 which are made of metal. When the environment is hot, the housing 30, which is fabricated from plastic material, expands more than the metal plates 42 and 44 which support the planet gears 46 between them. The result of this difference in expansion rates is less engagement between the teeth 46T on the lower planet gears 46 and the involute spur teeth 32 which stand vertically along the wall 34 inside the outer ring 36 of the housing 30.

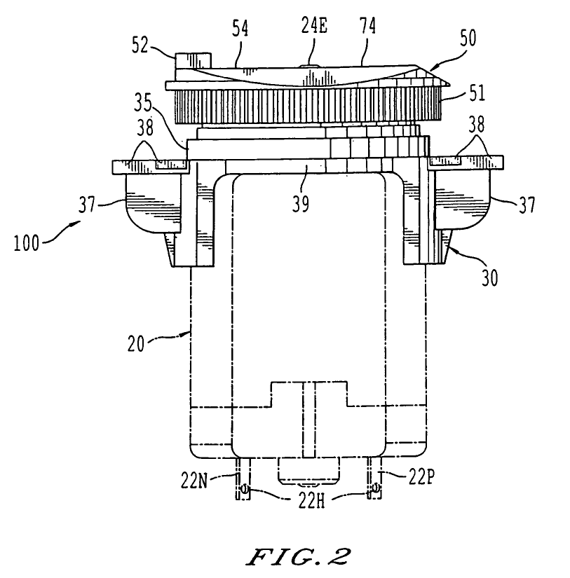

One way to restrict growth of the plastic housing 30 in the hot environment is either to make the outer ring 36 out of metal or to add a tight hoop ring 35 made of metal, as seen only in FIG. 2, surrounding the exterior wall 39 to help maintain engagement between the teeth 46T and the gear teeth 32 of FIG. 1 during normal operation which may include an abrupt stop due to a coin jam. It is most likely in the hot environment, particularly when a coin jams, that the gear train may become inoperative as a result of the gear train locking up. Thus, as shown in FIG. 2, the metal hoop ring 35 around the exterior wall 39 of the housing 30 reduces the possibility of the gear train locking up in a hot environment.

Another solution to the problem of less engagement between the teeth 46T and the gear teeth 32 of FIG. 1 in hot environments is to fabricate the housing 30 and/or the output gear 50 out of metal. This change in material would also result in less of a difference in thermal expansion between the housing 30, the cage 40 and the output gear 50.

In FIG. 2, the entire assembly 100 seen in solid lines is mounted on the D.C. motor 20 seen in dashed and dotted lines. The terminals 22P and 22N each have a hole 22H into which the connectors 18P and 18N of FIG. 1 are attached. Still referring to FIG. 2, inside the D.C. motor 20, there is an armature winding with a magnet wheel, both not shown, as would be present in any conventional motor, for turning the shaft 24 of FIG. 1. In FIG. 2, the upper end 24E of the shaft 24 is seen to protrude slightly above an upper surface 54 of the output gear 50. When the planetary gear motor assembly 100 is put together, one sees only the following: the housing 30 with its wings 38 supported by the brackets 37 and the exterior wall 39; and the output gear 50 with pinion teeth 51 above the exterior wall 39 and with a protruding lug 52 on its upper surface 54. See FIG. 1 for a complete perspective top view of the placement of the protruding lug 52 on the upper surface 54 of the output gear 50. Hidden from view when the planetary gear motor assembly 100 is put together are the following: the cage 40; the washer 60; and the cap 70, except for the top surface 74 of the cap 70.

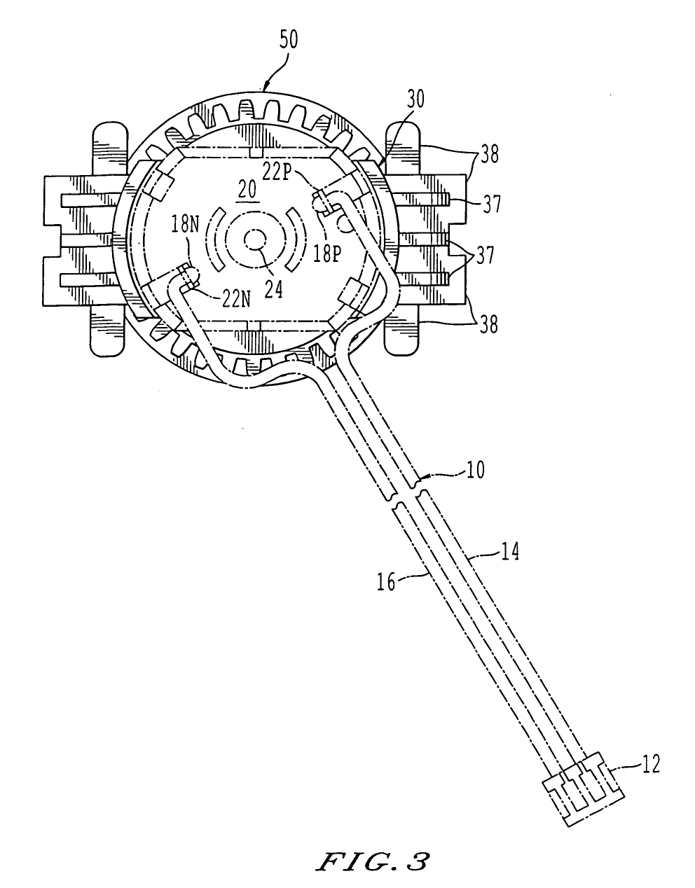

In FIG. 3, there is seen a bottom plan view in which the jack 12 of the harness 10 receives electric current from the external power source (not shown). The positive wire 14 carries the current from the jack 12 to the connector 18P while the negative wire 16 extends from the jack 12 to the connector 18N. The D.C. motor 20 has on its bottom end the pair of terminals 22P and 22N to which the connectors 18P and 18N, respectively, are attached. The shaft 24 protrudes from a bottom end of the motor 20. Partial views of the undersides of the output gear 50 and the housing 30 with its wings 38 supported by the brackets 37 are also seen in FIG. 3.

In FIG. 4A, there is seen an exploded perspective view of the cage 40 which has the top annular plate 42, the bottom annular plate 44 and the plurality of upper and lower planet gears 46 sandwiched therebetween. The top annular plate 42 has a center hole 42C while the bottom annular plate 44 has a coaxial center hole 44C through which the shaft 24 of FIG. 1 extends. The top annular plate 42 also has side notches 42N while the bottom annular plate 44 has corresponding side notches 44N. The function of the side notches 42N in the top plate 42 is to facilitate proper angular alignment for the final assembly of the top plate 42 to the bottom plate 44 with the assembled planet gears 46 and a sun gear 45. These side notches 42N and 44N in the upper plate 42 and the lower plate 44, respectively, are lined up with one another vertically in an assembly tool (not shown) to assure that pins 41 are perpendicular to horizontal surfaces of the plates 42 and 44 and to align bores 42B in the top plate 42 with the pins 41 that are standing in the bottom plate 44. The pins 41, being made of metal and being, for example, six in number, are press-fitted at one end into bores 44B in the bottom annular plate 44 and then are press-fitted at their opposite ends into the bores 42B in the top annular plate 42. However, before the pins 41 are forced into the bores 42B in the top annular plate 42, a stacked pair of upper and lower planet gears 46 is slipped over each pin 41. The cluster gears total six in number in this embodiment. The upper planet gears 46 each have ten teeth 46U while the lower planet gears 46 each have 12 teeth 46T. There is a small plate 46A between each pair of the upper and lower planet gears 46 to retain the gear mesh between the sun gear 45 and the lower planet gears 46. Each of the lower planet gears 46 of the cluster gears has its teeth 46T driven by teeth 45T of the sun gear 45 which is positioned in the center of the lower planet gears 46. The sun gear 46 carries a drive dog 47 on its upper surface for interaction with the lug 76 of the cap 70 seen in FIG. 1.

Referring to FIG. 4B, which is a side elevational view of the assembled cage 40, there is seen the plurality of cluster gears composed of upper and lower planet gears 46, respectively, stacked in pairs with one of the small plates 46A between each pair. The planet gears 46 are strung in pairs on the pins 41 which are then simultaneously staked at their ends to the annular plates 42 and 44, respectively. Thus, the planet gears 46 are sandwiched between the top annular plate 42 and the bottom annular plate 44. The sun gear 45 shown in FIG. 4A is only partially visible in FIG. 4B because it sits in the middle of the cluster of the lower planet gears 46 and it cannot be completely seen in the side view of FIG. 4B.

Referring to FIG. 4C, there is shown a partially broken away, top plan view of the assembled cage 40. One end of each of the pins 41 is press fitted in a different bore 42B of the top annular plate 42 with its side notches 42N. A hardened steel or carbide tool 49 makes an indentation 43 in a top surface of each pin 41. During a key manufacturing step, plural tools 49 are used simultaneously to make the indentations 43 in opposite top surfaces of all pins 41, as may be envisioned from FIG. 4B. The indentations 43 are caused when the top surfaces of all pins 41 deform and flare out slightly over the upper surface of the top annular plate 42 and the lower surface of the bottom annular plate 44. As a result of this extra manufacturing step, the structural integrity of the assembled cage 40 is retained during rotation of the planet gears 46 and during operation of the entire mechanism, especially when a coin is jammed. This staking step is much less expensive than soldering or riveting the pins 41 to the annular plates 42 and 44 of the cage 40.

Returning to FIG. 4C, each of the upper planet gears 46 with its teeth 46U is separated by one of the small plates 46A from a lower planet gear 46 (shown in the broken away view) with its teeth 46T. A timing mark 46M on each of the six upper planet gears 46 is aligned to the center C of the top annular plate 42 of the assembled cage 40. As seen in the partially broken away section of the assembled cage 40, the teeth 46T on each one of the lower planet gears 46 mesh with teeth 45T of the sun gear 45. On the upper surface of the sun gear 45, the drive dog 47 is pushed around in a circular path either clockwise or counterclockwise by the protruding leg 76 (not shown in FIG. 4C) which leg 76 extends down from the cap 70 of FIG. 1 through a center hole 42C in the top annular plate 42.

Any and all gears have certain inaccuracies due to normal manufacturing processes. One of these inaccuracies is the tooth to tooth variation when rolled with a master gear. A master gear is as close to a perfect gear that can be fabricated. Another inaccuracy is the total composite tolerance, sometimes referred to as total composite error. All gear trains must be designed to tolerate or allow for these inaccuracies. The total composite error is the sum total of all of the errors in a gear and also includes an out-of-roundness condition.

For example, the internal gear teeth 32 of the housing 30 shown in FIG. 1 have an out-of-roundness condition which occurs naturally, when the housing 30 is molded. This condition is also present in the output gear 50.

A planetary gear system also must be designed to allow for these inaccuracies. Ideally, if one had all perfect gears, the planetary gear system would operate on perfectly circular centers, as indicated in the U.S. Pat. No. 4,366,727 of Jonsson. However, if the gears are not perfect, these inaccuracies must be dealt with.

In this particular assembly 100, the design should not have constraints such as pilot diameters between the output gear 50 and the housing 30. The cage 40 has six planet gears 46 placed on the six pins 41. See FIG. 4A. Therefore, this construction is such that the cage 40 is restricted radially. With the close manufacturing tolerances required, it has been discovered that the cage 40, when in operation, does not remain on the center line of the housing 30, as seen in FIG. 4. In a like manner, the output gear 50 does not remain on the center line of the cage 40, when in operation. Thus, as illustrated in FIG. 4A, the plurality of the gears 46 should and does seek its own natural center by contact between surfaces of the adjacent teeth 46T and also by contact between surfaces of the adjacent teeth 46U on each of the planet gears 46.

In FIGS. 5A and 5B, there are seen a top plan view and a side elevational view, respectively, of the output gear 50 which has its upper surface 54 flat in a central portion thereof. Two side surfaces 56 are tapered on opposite long edges 54E of the central portion of the upper surface 54. A third side surface 58 is tapered on one short edge 54A of the central portion of the upper surface 54. The protruding lug 52 is molded integrally on the upper surface 54.

Referring exclusively to FIG. 5A, there is a ledge 53 recessed below a center hole 54C in the upper surface 54. The washer 60, shown only in FIG. 1, rests on the ledge 53 in FIG. 5A and is positioned between the cap 70 and the output gear 50. The cap 70 revolves at a much higher speed than the output gear 50, shown also in FIG. 1, when the cap 70 is positioned in the center hole 54C.

Referring exclusively to FIG. 5B, the output gear 50 has its plurality of pinion teeth 51 extending completely around its outer circumference below the upper surface 54 and the side surfaces 56 and 58. Inside the output gear 50, the pinion teeth 51 mesh with the teeth 46U on the upper planet gears 46, shown only in FIGS. 1, 4A, 4B and 4C, to drive the output gear 50 which carries the protruding lug 52 on its upper surface 54.

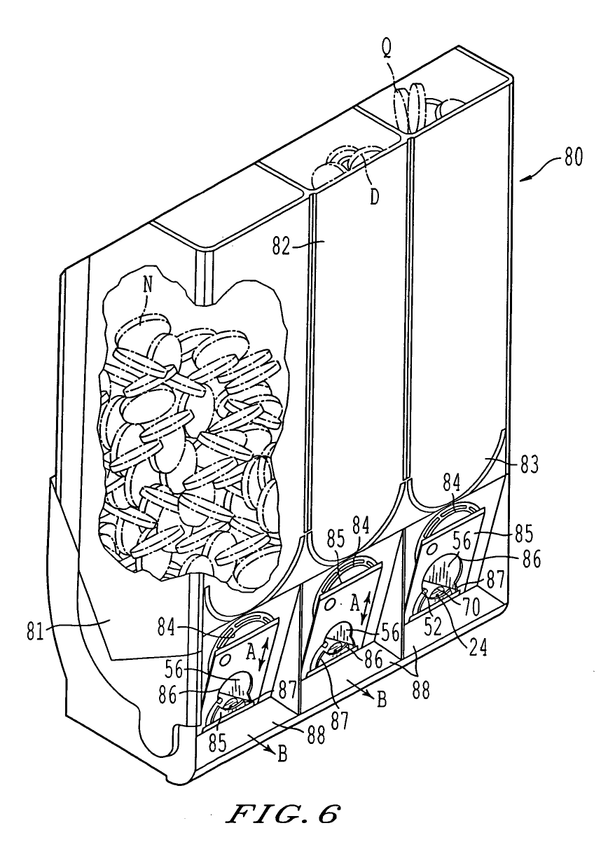

In FIG. 6, there is seen a perspective view of a coin dispensing mechanism 80 in which the planetary gear motor assembly 100 operates. The mechanism 80 is divided into a first compartment 81 holding an accumulation of nickels N dumped therein, a second compartment 82 holding the accumulation of dimes D, and a third compartment 83 holding an accumulation of quarters Q. At a bottom of each compartment 81, 82 and 83, there is a cylindrical chute 84 closed at its lower end by a shutter door 85 which is raised and lowered in the direction indicated by a double-headed arrow A. A churner (not shown) is situated in each chute 84 and stirs up the accumulation of coins until a single coin slides down the chute 84. The shutter doors 85 are molded out of plastic and each one has a round hole 86 formed therein and sized to capture the single coin coming down the chute 84. For example, in front of the third compartment 83, the shutter door 85 has its round hole 86 sized to catch and hold one quarter Q coming down the chute 84. Likewise, the shutter door 85 in front of the first compartment 81 has its round hole 86 sized to capture one nickel N and the shutter door 85 in front of the second compartment 82 has its round hole 86 sized to catch and hold one dime. In addition to the round hole 86, each shutter door 85 has formed therein an arcuate pathway 87 of at least 180° degrees in which the protruding lug 52 travels back and forth as it is rotated by the shaft 24 held by the cap 70. An inclined slide 88 directs each coin downwardly and outwardly in the direction of the single-headed arrow B after the coin is dropped out of the round hole 86 by the lug 52 traveling in the arcuate pathway 87 when the lug 52 traverses the round hole 86.

Thus, the interface between the planetary gear motor assembly 100 of FIGS. 1 and 2 and the coin dispensing mechanism 80 of FIG. 6 may be described in the following manner. The gear motor assembly 100 is mounted inside the coin dispensing mechanism 80 of FIG. 6 in such a way that the protruding lug 52 on the output gear 50 of FIGS. 5A and 5B fits into the arcuate pathway 87 formed in the shutter door 85 of FIG. 6. When the DC motor 20 of FIGS. 1 and 2 is energized, the output gear 50 of FIGS. 5A and 5B rotates at least 180°. This rotation of the output gear 50 is translated into linear motion in the direction of the arrow A in FIG. 6 by the protruding lug 52 which travels in the arcuate pathway 87 to raise and lower the shutter door 85. The round hole 86 in each door 85 is slightly larger than the coin which it is configured to capture and carry. One door 85 is positioned at the open end of each chute 84 at the bottom of each compartment 81, 82 and 83 in which accumulated nickels N, dimes D and quarters Q, respectively, are loosely held in a jumble.

When the door 85 is raised by the protruding lug 52 traveling in the arcuate pathway 87, a coin should drop into the round hole 86 in the door 85. The motor 20 of FIGS. 1 and 2 will hold the door 85 of FIG. 6 open in this position for enough time so that only one coin is captured and lodged in the round hole 86. The motor 20 of FIGS. 1 and 2 is then reversed in order to lower the door 85 of FIG. 6. When the door 85 returns to its initial rest position, the captured coin falls out of the round hole 86 and then falls down the slide 88 in the direction of the arrow B into another device (not shown) that either counts or senses the coin. If no coin appears in the round hole 86, this device (not shown) electronically instructs the motor 20 of FIGS. 1 and 2 to repeat the cycle described above. Each cycle occurs in a very short period of time, usually less than a second.

With reference again to FIG. 1, assembling the planet gears 46 presently requires that these gears 46 be aligned in a specific way to ensure that the output gear 50 can be correctly integrated into the planetary gear motor assembly 100. If the upper planet gear teeth 46U are not properly aligned, the pinion teeth 51 inside the output gear 50 will not line up with the upper planet gears 46. Thus, the procedural step for lining up the upper planet gear teeth 46U with the inside pinion teeth 51 requires considerable time and careful attention to detail.

One solution to this time-consuming and labor-intensive problem is to mold the plastic planet gears 46 in the proper alignment in such a way that the gears 46 can be subsequently assembled onto the pins 41 of FIG. 4A in the bottom annular plate 44 and then aligned with the sun gear 45 so as to allow the lower planet gear teeth 46T to engage with the teeth 45T of the sun gear 45.

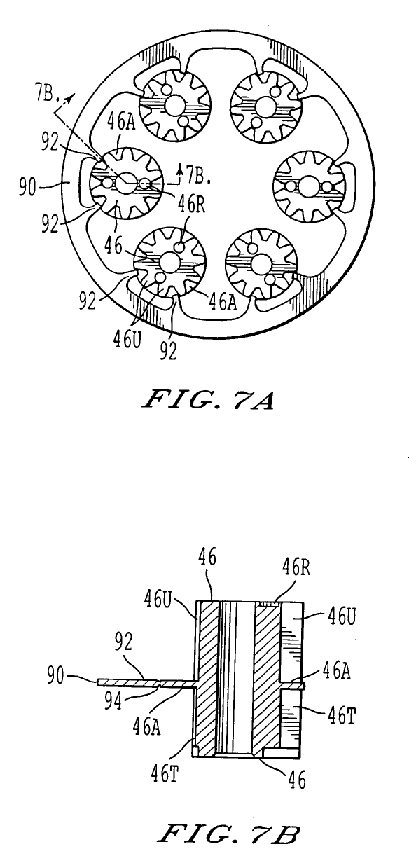

Referring to FIGS. 7A and 7B, this solution can be carried out by placing a molded ring 90 so as to hold the planet gears 46 in their proper positions during the method for manufacturing the planetary gear motor assembly 100, best shown in FIGS. 1 and 2.

As shown in FIGS. 7A and 7B, the molded ring 90 has a plurality of pairs of pointers 92. Each pair of pointers 92 is attached to a weakened edge 94 of each small plate 46A which is positioned below each upper planet gear 46. The pointers 92 are arranged so that two upper planet gear teeth 46U are located between each pair of pointers 92. Rings 46R are markers recessed in pairs on top of each upper planet gear 46. These rings 46R serve as identifiers for assemblers when putting together the planetary gear motor assembly 100 seen in FIGS. 1 and 2. If the molded ring 90 of FIGS. 7A and 7B is used in the method of manufacture, then the rings 46R replace the timing marks 46M in FIG. 4C.

The method for manufacturing the planetary gear motor assembly 100 shown in FIGS. 1 and 2 may be described in two steps: first, a so-called pre-assembly of the cage 40 seen in FIG. 4A; and second, a final assembly.

The first method step, i.e., the preassembly of the cage 40, will now be described with reference to FIGS. 4A, 4B, 4C, 7A and 7B. Referring first to FIG. 4A, the six pins 41 are initially press-fitted into the six corresponding bores 44B in the bottom annular plate 44. As seen in FIG. 4B, a slight length at the bottom of the pins 41 protrudes beyond being flush with the lower surface of the bottom annular plate 44. Likewise, a slight length at the top of the pins 41 protrudes above being flush with the upper surface of the top annular plate 42.

Referring back to FIG. 4A, the sun gear 45 is placed in the center of the six pins 41 with the drive dog 47 protruding upwardly. The six cluster gears are then placed on the pins 41. Note that the small plates 46A are each molded to form a single integral unit with one lower planet gear 46 underneath and one upper planet gear 46 above. Hence, each cluster is composed of the upper planet gear 46 stacked on top of the lower planet gear 46 with one small plate 46A molded therebetween to form this single integral unit. See also the cross section of FIG. 7B for showing one cluster or stacked pair of planet gears 46 with the small plate 46A forming together this single integral unit.

Referring now to both FIGS. 7A and 7B, the molded ring 90 and its pointers 92 are used to hold the teeth 46U of the upper planet gears 46 for subsequent alignment with the pinion teeth 51 inside the output gear 50, as best shown in FIG. 1. After the alignment, the molded ring 90 is removed by breaking each pointer 92 at the weakened edge 94 where contact is made with each small plate 46A.

The preassembly of the cage 40 is continued in FIG. 4A by press-fitting the top annular plate 42 so that its bores 42B fit onto the pins 41. As shown at the left side of FIG. 4B, a slight length at the tops of the pins 41 protrudes beyond being flush with the upper surface of the top annular plate 42. At this point, as seen in FIGS. 4B and 4C, plural tools 49 are pressed simultaneously to stake all six pins 41 from opposite ends into the plates 42 and 44. As a result, the indentations 43 are made in the top surfaces which deform and flare out over the upper surface of the top annular plate 42 and the lower surface of the bottom annular plate 44.

The second method step, i.e., the final assembly of the entire planetary gear motor assembly 100 will now be described with reference to FIGS. 1 and 2. Initially, as shown in FIG. 1, the housing 30 is placed on top of the D.C. motor 20 and is keyed thereto by at least two round projections 31, of which only one is shown, from a bottom of the housing 30 to fit loosely into corresponding holes 21 in a top surface of the D.C. motor 20. The assembled cage 40 is then placed inside the housing 30 so that the teeth 46T of the lower planet gears 46 mesh with the involute spur gear teeth 32 which stand vertically along the wall 34 inside the ring 36 of the housing 30. Then, if considered necessary, the metal hoop ring 35, seen only in FIG. 2, is slipped down to surround the exterior wall 39 of the housing 30. This metal hoop ring 35 could also be a molded plastic part. Next, the output gear 50 is placed over the assembled cage 40 in FIG. 1 so that the teeth 46U of the upper planet gears 46 mesh with the inside of the pinion teeth 51, better seen in FIG. 2. Returning to FIG. 1, the washer 60 is then placed on the ledge 53, better shown in FIG. 5A. This ledge 53 is recessed below the outer hole 54C in the upper surface 54 of the output gear 50.

Returning to FIG. 1, the cap 70 is pressed over the upper end 24E of the shaft 24 which extends upwardly through the center holes of the housing 30, the assembled cage 40, the output gear 50, the washer 60 and the cap 70, so that the upper end 24E of the shaft 24 is either flush with or protrudes from the top surface 74 of the cap 70. Since the cap 70 is frictionally fit into the washer 60, the output gear 50 and the assembled cage 40, the entire planetary gear motor assembly 100 is held together. Finally, the harness 10 is attached to the bottom of the D.C. motor 20 by securing the connectors 18N and 18P to the terminals 22N and 22P, respectively.

The operation of the entire planetary gear motor assembly 100 will now be described with reference to FIGS. 1 and 6. When the D.C. motor 20 is energized by a current of electricity from the external power source (not shown), the shaft 24 rotates the cap 70 which has already been fitted onto the upper end 24E of the shaft 24.

The leg 76 of the cap 70 extends into the assembled cage 40 and contacts the drive dog 47, shown only in FIGS. 4A and 4C, to cause the sun gear 45 to rotate. The teeth 45T on the sun gear 45 mesh with the teeth 46T of the lower planet gears 46 which cause the upper planet gears 46 to rotate. Note that the teeth 46T on the lower planet gears 46 are more numerous than the teeth 46U on the upper planet gears 46 which engage the inside of the pinion teeth 51 on the output gear 50. Referring back to FIG. 1, as the upper planet gears 46 drive the output gear 50, the protruding lug 52 on the upper surface 54 of the output gear 50 travels in the arcuate pathway 87 shown in FIG. 6 to open and close the shutter door 85 so that a coin is dispensed in the manner previously described in regard to FIG. 6.

Certainly, numerous additional modifications and variations of the present inventive assembly and method are possible in light of the above teachings. Thus, it is to be understood that, within the scope of the appended claims, the present invention may be practiced with structure and steps other than the structure and steps specifically described hereinbefore.

1. A planetary gear motor assembly for opening and closing a shutter door on a coin dispensing mechanism, said assembly including an assembled cage having a pair of annular plates with a plurality of stacked pairs of planet gears sandwiched between the pair of annular plates, wherein the improvement comprises:
a plurality of pins on which the pairs of planet gears are stacked, each of the pins being staked at opposite ends to the pair of annular plates so that structural integrity of the assembled cage is retained during rotation of the planet gears.

2. A planetary gear motor assembly according to claim 1, wherein:
each of the pins at their opposite ends has an indentation therein caused by being staked to the pair of annular plates.

3. A planetary gear motor assembly according to claim 1, wherein:
each of the pins at their opposite ends is flared at an upper surface of a top one of the pair of annular plates and a lower surface of a bottom one of the pair of annular plates.

4. A planetary gear motor assembly according to claim 1, wherein:
said plurality of stacked pairs of planet gears is allowed to seek its own natural center by contact between surfaces of adjacent teeth on each of the planet gears.

5. A planetary gear motor assembly according to claim 1, further comprising:
a sun gear positioned centrally among lower ones of the planet gears.

6. A planetary gear motor assembly for opening and closing a shutter door on a coin dispensing mechanism, said assembly comprising:
a housing having an exterior wall;
an assembled cage placed inside the housing, said cage having a pair of annular plates, a plurality of cluster gears composed of upper and lower planet gears sandwiched between the pair of annular plates, and a plurality of pins on which the cluster gears are placed, each of the pins being staked at opposite ends to the pair of annular plates so that structural integrity of the assembled cage inside the housing is retained during rotation of the planet gears; and
an output gear mounted over the housing and configured to open and to close the shutter door.

7. A planetary gear motor assembly according to claim 6, wherein:
each of the pins at their opposite ends has an indentation therein caused by being staked to the pair of annular plates.

8. A planetary gear motor assembly according to claim 6, wherein:
each of the pins at their opposite ends is flared at an upper surface of a top one of the pair of annular plates and a lower surface of a bottom one of the pair of annular plates.

9. A planetary gear motor assembly according to claim 6, further comprising:
a hoop ring surrounding the exterior wall of the housing.

10. A planetary gear motor assembly according to claim 6, wherein:
said plurality of cluster gears is allowed to seek its own natural center by contact between surfaces of adjacent teeth on each of the planet gears.

11. A planetary gear motor assembly according to claim 6, further comprising:
a sun gear positioned centrally among the lower planet gears.

12. A method of manufacturing a planetary gear motor assembly for opening and closing a shutter door on a coin dispensing mechanism, said method including the step of assembling a cage having a pair of annular plates with a plurality of cluster gears composed of upper and lower planet gears sandwiched between the pair of annular plates, wherein the improvement comprises a step of:
staking a plurality of pins, on which the cluster gears are placed, at opposite ends to the pair of annular plates;
whereby structural integrity of the cage is retained during rotation and abrupt stopping of the planet gears.

13. A method of manufacturing according to claim 12, wherein:
said staking step causes an indentation to be made in each of the pins at their opposite ends.

14. A method of manufacturing according to claim 12, wherein:
said staking step causes each of the pins at their opposite ends to flare out at an upper surface of a top one of the pair of annular plates and a lower surface of a bottom one of the pair of annular plates.

15. A method of manufacturing a planetary gear motor assembly for opening and closing a shutter door on a coin dispensing mechanism, said method comprising steps of:
providing a housing with an exterior wall;
placing an assembled cage inside the housing, said cage having a pair of annular plates, a plurality of cluster gears composed of upper and lower planet gears sandwiched between the pair of annular plates, and a plurality of pins on which the cluster gears are placed, each of the pins being staked at opposite ends to the pair of annular plates so that structural integrity of the assembled cage inside the housing is retained during rotation and abrupt stopping of the planet gears; and
mounting on the housing an output gear configured to open and to close the shutter door.

16. A method of manufacturing according to claim 15, wherein:
each of the pins at their opposite ends has an indentation therein caused by being staked to the pair of annular plates.

17. A method of manufacturing according to claim 15, wherein:
each of the pins at their opposite ends is flared out over an upper surface of a top one of the pair of annular plates and a lower surface of a bottom one of the pair of annular plates.

18. A method of manufacturing according to claim 15, further comprising the step of:
surrounding the exterior wall of the housing with a hoop ring.

19. A method of manufacturing according to claim 15, further comprising the step of:
using a molded ring to align the plurality of cluster gears composed of the upper and lower planet gears inside the housing with the output gear.

20. A method of manufacturing according to claim 19, further comprising the step of:
removing the molded ring from the plurality of cluster gears by breaking the molded ring at a weakened edge.
